(19) United States
(12) Patent Application Publication
(10) Pub. No.: US 2010/0324908 A1
(43) Pub. Date: Dec. 23, 2010

(54) Learning Playbot

(76) Inventors: Roy Rosser, Princeton, NJ (US); Sheldon Sturges, Princeton, NJ (US)

Correspondence Address: r.r (princeton), 56 MALDENHEAD ROAD, PRINCETON, NJ, 08540, US

(21) Appl. No.: 12/839,223

(22) Filed: Jul. 19, 2010

Related U.S. Application Data
(63) Continuation-in-part of application No. 10/536,476, filed on May 23, 2005, now Pat. No. 7,783,486.
(60) Provisional application No. 61/364,701, filed on Jul. 15, 2010.

(51) Int. Cl. G10L 21/00

(52) U.S. Cl. 704/270; 704/E11.001

(57) ABSTRACT

An enhanced chatbot, programed to learn from human-computer conversational exchanges. The process of learning automatically creates an expanded and updated statement/response database from input provided by users engaged in interactions with the chatbot.

### CROSS REFERENCE TO APPLICATIONS

This application is a Continuation-in-Part of, and claims priority from, U.S. application Ser. No. 10/536,476 entitled “Response Generator for Mimicking Human-computer Natural Language” filed by R. Rosser et al. on May 23, 2005, the contents of which are hereby incorporated by reference.

This application is further related to, and claims priority from, U.S. Provisional Patent application No. 61/364,701 filed on Jul. 15, 2010, by R. Rosser et al. entitled “Learning Playbot”, the contents of which are hereby incorporated by reference.

### TECHNICAL FIELD

The present invention relates to computer games, and more particularly to computer chatbots having an ability to learn from the person engaged in conversation with them and to implement a conversational game strategy.

### BACKGROUND ART

There is significant interest in creating computer programs that successfully mimic human conversational exchanges. Such programs would be of considerable utility as, for instance, the interface to query systems used in customer service industries to automate responses to routine inquiries. Such programs would also be useful in education, entertainment and marketing by providing automated routine training, as game elements and in automated telemarketing campaigns.

What may be needed for a computer to successfully mimic a human conversation is a relatively simple computer program having a database with about 6-10 million prepackaged responses. Current Personal Computers (PC) typically have the memory and processing power to handle such databases. An obstacle to creating such data bases is the enormous task of creating and updating them. This may be particularly challenging if the databases ore to remain current, reflecting changing events, fashions and fads.

### SUMMARY OF INVENTION

### Technical Problem

The technical problem addressed by the present invention includes, but is not limited to, programming, or otherwise enabling, a computer or similar electronic device, to interact with a user by mimicking a human conversational exchange. In particular, a part of the technical problem is to provide, and continuously update, a large enough statement/response database to quasi-realistically mimic a human conversational exchange.

### Solution to Problem

The present invention solves the technical problem by providing an enhanced chatbot, programed to learn from human-computer conversational exchanges. The process of learning automatically creates an expanded and updated statement/response database from input provided by users engaged in interactions with the chatbot.

### ADVANTAGEOUS EFFECTS OF INVENTION

Advantages effects of the invention include, but are not limited to, providing a user with an automated system that mimics a human conversation, providing a more natural interface between humans and computers.

These and other features of the invention will be more fully understood by references to the following drawings.

### BRIEF DESCRIPTION OF DRAWINGS

FIG. 1 shows a schematic layout of an exemplary embodiment of a playbot of the present invention.

FIG. 2 shows a schematic flow diagram of representative steps in the operation of an exemplary embodiment of a playbot of the present invention.

FIG. 2 shows a schematic flow diagram of representative steps in the operation of an exemplary embodiment of a playbot 100 of the present invention.

### DESCRIPTION OF EMBODIMENTS

“Chatbot” technology is well-know technology used, for instance, on the Internet, particularly in text mediated exchanges such as Instant Messaging (IM), as described in, for instance, in U.S. Pat. No. 6,430,602 titled “Method and system for interactively responding to instant messaging requests” issued to Kay, et al. on Aug. 6, 2002, the contents of which are hereby incorporated by reference.

Chatbot technology typically uses pattern matching techniques to match a query to a database entry and then responds with an answer formulated from that entry. In a simple form, a database will hold query-answer templates as two matching parts. For instance, a query such as:
“What is the longest river in the world?”
   will have a matching answer:
“The longest river in the world is the Nile”.

In this way whenever a question is asked that is the same as, or can be simply parsed to be the same as, an existing question in the Bot's database, it will respond with the stored answer.

Further developments in chatbot were described in detail in U.S. application Ser. No. 10/536,476 entitled “Response Generator for Mimicking Human-computer Natural Language” filed by R. Rosser et al. on May 23, 2005, the contents of which are hereby incorporated by reference.

This invention of playbots extends previous chatbots technology to, for instance, incorporate automated learning by the playbot while it is engaged in a game-like, mimicked conversation with a user.

Embodiments of the present invention will now be described in detail by reference to the accompanying drawings in which, as far as possible, like elements are designated by like numbers.

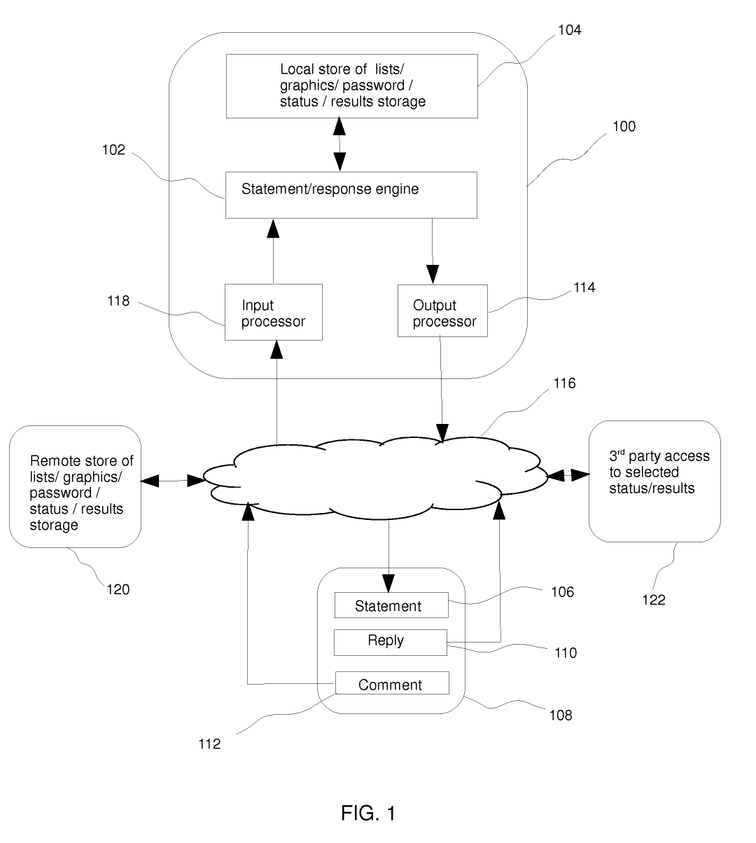

FIG. 1 shows a schematic layout of an exemplary embodiment of a playbot 100 of the present invention. The playbot 100 includes a statement/response engine 102, a local store 104, an input processor 118 and an output processor 114. The local store 104 may provide local storage for items such as, but not limited to, a statement response list, a list of continuation phrases, a list of acknowledgment phrases, graphics files and counters for keeping track of a game-score.

The playbot 100 may be connected to a remote store 120 via a communications network 116. The communications network 116 may be a digital network such as, but not limited to, the Internet, a wireless communication network, a satellite network or a fiber-optic network, or some combination thereof. The remote store 120 may store items such as, but not limited to, lists, graphics, passwords, status and results, or some combination thereof.

The playbot 100 may be connected via the communications network 116 to a remote game unit 108. The remote game unit 108 may be an electronic device such as, but not limited to, a cellphone, a personal computer, a game console or a television.

In operation, the statement/response engine 102 may select a statement 106 from the local store 104 and pass the statement 106 on to the output processor 114. The output processor 114 may modify the statement by, for instance, altering some or all of the spelling, or by altering the word order, or by inserting or deleting words, or by converting a text input to an audio output, or some combination thereof. The output processor 114 may then deliver the statement 106 to the remote game unit 108 via the communications network 116. The remote game unit 108 may then display the statement 106.

The user may then use the remote game unit 108 to either enter a reply 110 to the statement 106 or to enter a comment 112 on the statement 106.

The a reply 110 or the comment 112 entered by the user may then be sent back to the input processor 118 of the playbot 100 via the communications network 116. The input processor 118 may alter the user-response by, for instance, converting an audio signal to a text signal.

A text version of the user-response may then be sent to the statement/response engine 102 for processing.

If the user-response is a reply 110 to the statement 106, the statement/response engine 102 may select a further statement from the statement/response list in the local store 104. The statement/response engine 102 may also update a game score on the local store 104. The new statement may then be sent to the remote game unit 108.

If the user-response to the statement 106 is a comment on the statement 106, the statement/response engine 102 may, for instance, incorporate the user-response into the statement/response list, select an acknowledgment phrase from an acknowledgment phrase list stored in the local store 104, and send the acknowledgment phrase to the remote game unit 108 to be displayed. The statement/response engine 102 may also appropriately update the game score on the local store 104.

At an appropriate time such as, but not limited to, the termination of a game, the user may elect to allow a third party remote game unit 122 have access to data such as, but not limited to, selected status or results data, or selected conversation transcripts or some combination thereof.

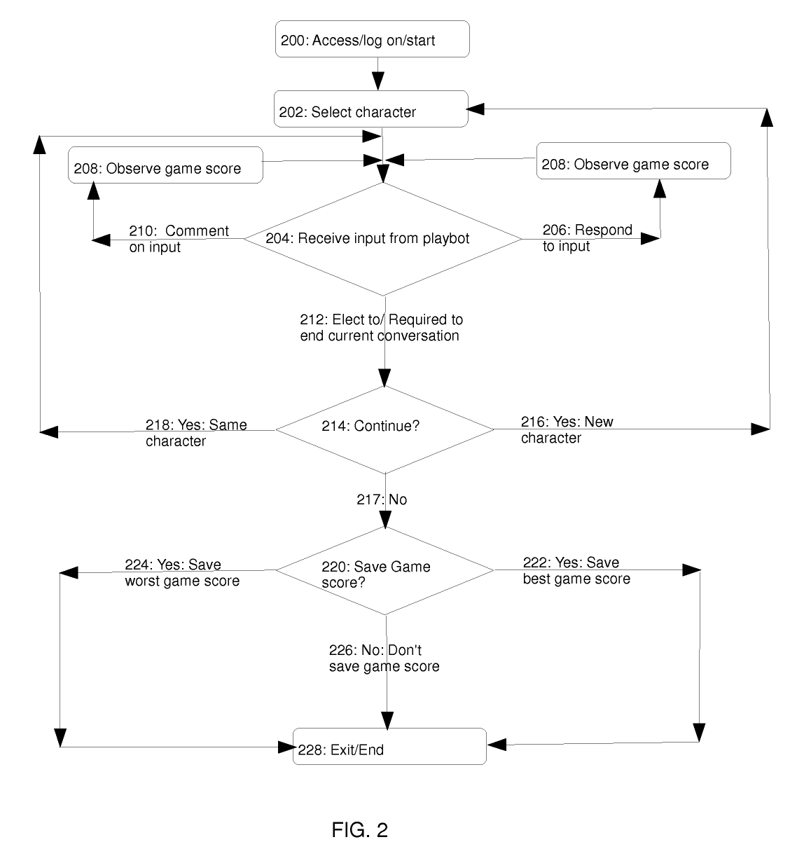

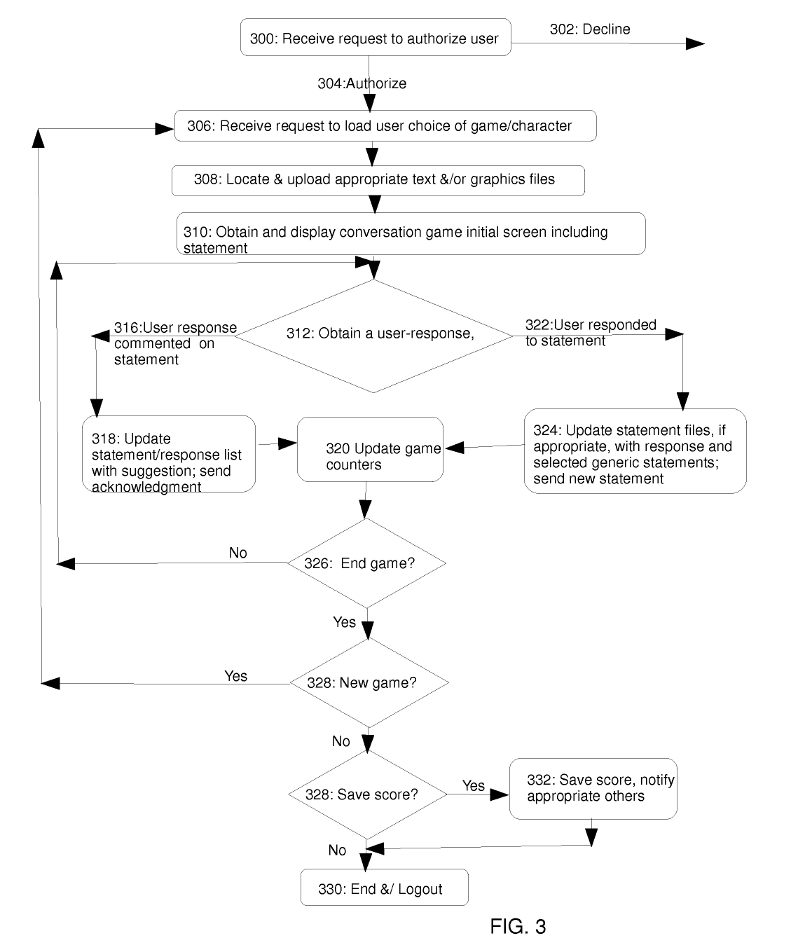

FIG. 2 shows a schematic flow diagram of representative steps in the operation of an exemplary embodiment of a playbot 100 of the present invention.

In step 200 the user may access the playbot 100. This access may, for instance, involve a password or other means of identification.

Having activated the playbot software, the user may then be required in step 202 to select a character. The selected character may, for instance, be chosen from a list of files.

In step 204, the user receives input from the playbot. This input may include, but is not limited to, graphics file, a statement and options to comment on or reply to the statement, or some combination thereof.

If, in step 206, the user elects to respond to the input, the user may then observe the game score in step 208. The user may, for instance, be interested in the game score to see how their response influenced it. The user may then loop back to step 204 and receive further input from the playbot 100.

If, in step 210, the user elects to comment on the input, the user may then observe the game score in step 208. The user may, for instance, be interested in the game score to see how their response influenced it. The user may then loop back to step 204 and receive further input from the playbot 100.

After receiving input from the playbot 100 in step 204, the user may elect to, or be required to end the current conversation. This may, for instance, be a result of the game-score reaching a predetermined termination value, or coming within a predetermined termination range.

Once the current conversation has been terminated, the user may, in step 218 elect to continue the game with another conversation with the same character. The user may then loop back to step 204 and receive input from the playbot that mimics a conversation by the originally selected character.

The user may instead, in step 216, elect to continue the game but elect to select a new character. The user may then loop back to step 202 and be offered the opportunity to select a new character.

The user may instead, in step 217, elect to end the game and may then be offered, in step 220, the choice of whether to save the game score, and that choice may further include the options of saving the best conversation score obtained during the game session in step 222, or the worst conversation score obtained during the game session in step 224. After either selection the user will then move to step 228 in which the user exits from the system, or ends the current session. If, in step 226, the user elects not to save the game score, they may also move to step 228, in which the user exits from the system, or ends the current session.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention. Modifications may readily be devised by those ordinarily skilled in the art without departing from the spirit or scope of the present invention.

FIG. 2 shows a schematic flow diagram of representative steps in the operation of an exemplary embodiment of a playbot 100 of the present invention.

In step 300, the playbot 100 may receive a request to authorize a user. This may, for instance, involve matching a password to a user name, or some similar authentication procedure. If the authentication procedure fails, the playbot 100 may, in step 302, decline access to the user.

If the authentication procedure is successful, the playbot 100 may, in step 304, authorize the user to proceed.

The playbot 100 may then, in step 306, receive a request to load a particular game or character selected by the user.

The playbot 100 may then, in step 308, locate and upload the appropriate text and graphics files for the selected game or character. The files may be stored locally or remotely, and may, for instance, include files such as, but not limited to, an answer/response list, a list of continuation phrases, a list of acknowledgment phrases, a list of termination phrases and one or more graphics files, or some combination thereof.

In step 310, the playbot 100 may obtain and display a conversation game initial screen including an opening statement.

In step 312, the playbot 100 may obtain a user-response.

If, in step 322, the playbot 100 determines that the user responded to the statement, the playbot 100 may move to step 324 and update the statement file by providing another statement, selected from the statement/response list by appropriate matching. The playbot 100 may also update one or more game-score counters in step 320, one or more of which may have numeric values indicative of the progress of the conversation game.

If instead, in step 316, the playbot 100 determines that the user commented on the statement by, for instance, suggesting a more appropriate statement that the playbot 100 should have made, the playbot 100 may then update the statement/response list using the user-response. The playbot 100 may also select one or more acknowledgment phrases from an acknowledgment phrase list and send the acknowledgment to the user. The playbot 100 may also update one or more game-score counters, one or more of which may have numeric values indicative of the progress of the conversation game.

In step 326, the playbot 100 may check to see if the current conversation or game should be terminated. If the user has not selected to terminate the game, and the current game score is not within a predetermined termination range, or not at a predetermined termination value, the conversation game may continue by the playbot 100 looping back to step 312.

If either If the user has selected to terminate the game, or the current game score is within a predetermined termination range, or at a predetermined termination value, the conversation game may be terminated by the playbot 100 moving on to step 328.

In step 328, the user may be given the option to start a new game or conversation.

If the playbot 100 receives a request to start a new game, the playbot 100 may loop back to step 306.

If the user elects not to start a new game or conversation, the playbot 100 may move to step 328 and offer the user the option to save one or more scores. The offer may also include an offer to store the transcript of one or more of the conversations related to the score.

If, the user elects to save one or more scores, the playbot 100 may further offer the user the option of sharing the score with a selected set of third parties. The offer may also include an offer to share one or more transcripts with the same or a different set of third parities. The playbot 100 may then proceed to step 330 and end or terminate the game session, and also carry out the instructions obtained in step 332.

If the user elects not to save any scores, the playbot 100 may then proceed to step 330 and end or terminate the game session.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method of automatically mimicking a conversation, said method comprising:
providing a statement/response list comprising at least one paired combination comprising a statement and at least one corresponding response;
providing a list of one or more continuation phrases;
providing a list of one or more acknowledgment phrases;
initiating a game-score counter;
displaying a first statement selected from said statement/response list;
receiving a user-response to said displayed first statement;
determining if said user-response comments on said first statement, or replies to said first statement; and
if said user-response replies to said first statement, initiating an action comprising obtaining and displaying a second statement corresponding to said use-response and updating said game-score counter; else, if said response comments on said first statement, initiating an action comprising incorporating said user-response into said statement/response list, updating said game-score counter, selecting an acknowledgment phrase from said list of acknowledgment phrases and displaying said selected acknowledgment phrase.

2. The method of claim 1, further comprising:
providing a list of one or more termination phrases; and
subsequent to updating said game-score counter, comparing a numeric value determined by said game-score counter with a predetermined termination-value and if said comparison yields a result within a predetermined range, initiating termination of said automatically mimicked conversation, said initiating termination comprising selecting a termination phrase from said list of termination phrases and displaying said selected termination phrase.
